(19) United States
(12) Patent Application Publication
(10) Pub. No.: US 2009/0222500 A1
(43) Pub. Date: Sep. 3, 2009

(54) Information storage device and method capable of hiding confidential files

(75) Inventors: Yu-Ting Chiu, Taipei City (TW); Chih Liang Yen, Taipei City (TW)

Correspondence Address: BACON & THOMAS, PLLC, 625 SLATERS LANE, FOURTH FLOOR, ALEXANDRIA, VA, 22314-1176, US

(73) Assignee: WareMax Electronics Corp., Taipei City (TW)

(21) Appl. No.: 12/379,497

(22) Filed: Feb. 24, 2009

(30) Foreign Application Priority Data
Feb. 29, 2008 (TW) 097107105

(51) Int. Cl. G06F 17/30

(52) U.S. Cl. 707/205; 707/E17.01

(57) ABSTRACT

The present invention is to provide a method implemented to an information storage device comprising a storage unit and a secret chamber management unit, wherein the storage unit is connected with a computer device through the secret chamber management unit for allowing the computer device to obtain a storage capacity of the storage unit. The secret chamber management unit sets an access authority selectively over the entirety or a part of the storage unit and formats the storage unit according to a command and a password inputted by a user, so as to create at least one physical open storage area and at least one physical hidden storage area in the storage unit. In addition, an allocation management area is defined in the secret chamber management unit or the storage unit for storing management information related to the open storage area and the hidden storage area.

### FIELD OF THE INVENTION

The present invention relates to hiding confidential files, more particularly to an information storage device comprising a secret chamber management unit and a storage unit for creating at least one physical open storage area and hidden storage area in the storage unit and defining an allocation management area in the secret chamber management unit or the storage unit for storing management information related to the open and hidden storage areas, so as to enable the secret chamber management unit to select, according to command and password inputted by a user, whether or not to allow a computer device to access confidential files in the physical hidden storage area or to display the confidential files thereon.

### BACKGROUND OF THE INVENTION

Recently, with the rapid development of the electronic technology industry, a wide variety of electronic products (e.g., notebook computers, personal digital assistants, digital cameras, mobile phones, etc.) are produced, with constantly improved functions, continuously descending prices and ever-decreasing volumes, so as to become important, if not indispensable, tools for many people in their daily lives and at work. Under this trend, a lot of people are now accustomed to storing various confidential files (e.g., data files, image files, voice files, etc.) generated by these electronic products in information storage devices such as hard drives, USB flash drives and so on. Therefore, it has been a key issue in the information era to provide people, companies or organizations in general with a secure means for storing those important confidential files in life and at work.

In view of the above and to facilitate dynamic management of information, designers and manufacturers of information storage devices developed a variety of portable information storage devices such as external hard drives, removable hard drives, IC cards, smart cards, USB flash drives and so forth. In addition to large storage sizes sufficient for people, companies or organizations in general to store important information in life and at work, these information storage devices provide plug-and-play portability so as to be carried around by users and kept in one place to ensure information security. However, such information storage devices have never been provided with significantly effective information security mechanisms for protecting the files and data stored therein. As a result, confidential files in such information storage devices are subject to unauthorized access, or may leak out when the information storage devices are sent for repair, or may be deleted or overwritten due to improper operation or maintenance of the information storage devices so that the files are no longer good for use. All the above scenarios cause serious trouble to the owners of the confidential files and may even lead to significant loss of personal or corporate reputation or property.

Conventionally, an information security mechanism uses a common password or software-based security mechanism to protect confidential files stored in an information storage device. Besides, confidentiality of an information storage device can be enhanced by using removable hard drives. Nevertheless, the conventional information security mechanisms still have the following drawbacks:
(1) Information security mechanism using hidden directories to encrypt files: An information storage device implementing this information security mechanism is provided with a hidden directory. A user can use a mouse to right-click on a file and drag the file into the hidden directory so that the hidden directory automatically encrypts the file. When the user right-clicks on an encrypted file and drags it out of the hidden directory, the hidden directory requests the user to input a password and then decrypts the encrypted file according to the password inputted by the user, before the user is allowed to use the file. This approach is disadvantageous in that the user must memorize the password so as to input the password correctly when dragging an encrypted file out of the hidden directory and thus allow the hidden directory to decrypt the file accordingly. Failure to memorize and correctly input the password prevents the user from opening an encrypted file in the hidden directory. In addition, after using a decrypted file, the user must not forget to drag the file back into the hidden directory and delete the clear text version of the file outside the hidden directory, otherwise the file will be totally unprotected.
(2) Information security mechanism using software to encrypt files: An information storage device implementing this information security mechanism uses an encrypting software to convert a file to be protected into an encrypted file (e.g., by compressing the file into an encrypted winzip file). When a user attempts to open an encrypted file by right-clicking thereon with a mouse, the encrypting software requests the user to input a password and then decrypts the file according to the password inputted by the user, before the user is allowed to use the file. One drawback of this approach is that, as with the previous approach, the encrypted file cannot be opened unless the user memorizes the password. Besides, after using the file, the user must encrypt the file again with the encrypting software and input the password, otherwise the file is left totally unprotected.

In either of the file encryption approaches described above, the filename of an encrypted file is displayed in the file directory of an information storage device to enable user selection, and the user must remember the password and correctly input the password when right-clicking on the encrypted file in order to open it. Thus, the conventional information security mechanisms not only involve complicated and user-unfriendly operation procedures, but outlaws are likely to cast a furtive glance at encrypted files whose filenames are shown in the file directory of the information storage device. Consequently, confidential information may be accessed if the conventional information security mechanisms are cracked with special decryption programs or techniques.

Therefore, in order to solve the problem that the filenames of encrypted files are always present in the file directory of an information storage device, developers put forward a virtual storage space to be created in the information storage device, whereby after confidential files are stored in the virtual storage space, information related to the virtual storage space, such as the path thereof and the filenames of files stored therein, is hidden to avoid unauthorized and illicit access. In addition, an encryption technique is developed for use with virtual hard drives, whereby a virtual storage space for storing confidential files in an information processing device is encrypted so that only when a correct password is inputted by a user will the virtual storage space be accessible, and the filenames of confidential files stored therein be displayed in the file directory of an information storage device for selection by the user. This technique is explained below in detail by reference to FIG. 1.

An encryption technique program is stored in a removable USB flash drive (or IC card or smart card) 10. If a user wants to store a confidential file generated by a computer 11 in an external hard drive 12, the user must insert the USB flash drive 10 into the computer 11, allowing the computer 11 to read the encryption technique program pre-stored in the USB flash drive 10 and create at least one virtual storage space (i.e., virtual hard drive) in the external hard drive 12 according to the encryption technique program (including a preset password or fingerprint identification data), for storing the confidential file. The computer 11 uses the encryption technique program to encrypt the confidential file, then stores the encrypted confidential file in the virtual storage space, and finally stores back into the USB flash drive 10 the drive paths of the encrypted confidential file and of the virtual storage space in the external hard drive 12, along with relevant management information. Thus, when the USB flash drive 10 is removed from the computer 11, all encrypted confidential files stored in the virtual storage space must, in theory, be hidden against unauthorized access or theft. If the user wants to use the encrypted confidential file stored in the external hard drive 12, all he/she has to do is insert the USB flash drive 10 into the computer 11 so that the computer 11 can read the pre-stored encryption technique program from the USB flash drive 10, decrypt the encrypted confidential file stored in the virtual storage space according to the preset password (or fingerprint identification data) in conjunction with the drive paths and the management information stored in the USB flash drive 10, and display a file directory of confidential files on a screen 111 of the computer 11 for the user to select from.

However, according to tests and research conducted by the inventor of the present invention on commercially available USB flash drives implementing the foregoing encryption technique, breach of information security and integrity is still possible with such technique, as explained below. Referring to FIGS. 1 and 2, a device directory 20 displayed on the screen 11 1 of the computer 1 1 shows that the computer 11 has a hard drive with a drive letter (C:) and is further connected with an external hard drive 12 with a drive letter (G:) and a total capacity of 29.2 GB. When the USB flash drive 10 is inserted into the computer 11, the device directory 20 simultaneously shows a CD-ROM drive with a drive letter (D:) and a removable drive with a drive letter (F:), as shown in FIGS. 2 and 3. The computer 11 reads and executes the pre-stored encryption technique program (e.g., an interface program) in the USB flash drive 10, allowing the user to create through the computer 11 at least one virtual storage space in the external hard drive 12 for storing confidential files, namely the three virtual hard drives in FIG. 3 with drive letters (O:), (P:) and (Q:), respectively, according to the encryption technique program (including the preset password or fingerprint identification data). The computer 11 then uses the encryption technique program to encrypt the confidential files and stores the encrypted confidential files in the virtual storage space. As a result, the available space in the external hard drive 12 is reduced to 23.3 GB. After the USB flash drive 10 is removed from the computer 11, the virtual storage space and all the encrypted files stored therein are hidden. However, the difference between the total capacity and the available space of the external hard drive 12 as shown in the device directory 20 is revealing enough to tempt people with unlawful intentions to use special decryption programs or techniques to crack the security mechanism and steal the confidential information protected thereby.

Besides, a more serious problem may happen when the user or a third party (e.g., a maintenance engineer) attempts to format the external hard drive 12, as shown in FIGS. 4 and 5. Since the computer 11 cannot distinguish between the attributes of the virtual storage space (i.e., the three virtual hard drives with the drive letters (O:), (P:) and (Q:)) and of the external hard drive 12, when the computer 11 completes formatting the external hard drive 12, it is clearly shown by the device directory 20 displayed on the screen 111 of the computer 11 that the total capacity of the external hard drive 12 is restored to 29.2 GB, as shown in FIG. 6, meaning that the virtual storage space (i.e., the three virtual hard drives with the drive letters (O:), (P:) and (Q:)) is completely formatted or destructively overwritten so as to disappear from the external hard drive 12. In consequence, all the confidential files stored in the virtual storage space are irrevocably lost.

Therefore, the research and development of an information storage device and method capable of hiding confidential files has been an important issue that demands serious efforts from the relevant industry. It is hoped that a user can store confidential files in an information storage device and rest assured that no one else can find the possible storage locations of the confidential files through computer, nor will the confidential files stored in the information storage device be lost forever should someone format the information storage device.

### BRIEF SUMMARY OF THE INVENTION

In view of the shortcomings of the conventional information security mechanisms, the inventor of the present invention, based on years of practical experience and after conducting pertinent research and experiments, finally succeeded in developing an information storage device and method capable of hiding confidential files as disclosed herein. Thus, the present invention provides a file storage technique which not only enhances privacy protection and information security, but also effectively facilitates access of confidential files.

An objective of the present invention is to provide an information storage method capable of hiding confidential files, wherein the method is applicable to an information storage device (e.g., built-in hard drive, external hard drive, USB flash drive, IC card and other electronic devices for storing digital information) comprising a storage unit (e.g., hard drive, flash memory, etc.) and a secret chamber management unit. The storage unit is connected with a computer device (e.g., desk-top computer, notebook computer, personal digital assistant, mobile phone, etc.) through the secret chamber management unit, and the secret chamber management unit is installed therein with a user interface allowing the computer device to read and execute the user interface and obtain a storage capacity of the storage unit through the secret chamber management unit. The secret chamber management unit sets an access authority selectively over the entirety or a part of the storage unit and formats the storage unit according to a command and a password inputted via the user interface, so as to create at least one physical, open storage area and at least one physical, hidden storage area in the storage unit. In addition, an allocation management area is defined in the secret chamber management unit or the storage unit. Afterward, management information related to the open storage area and the hidden storage area is stored in the allocation management area.

Another objective of the present invention is to provide the foregoing information storage method, wherein the secret chamber management unit selects, according to the command and the password inputted via the user interface, whether or not to allow the computer device to access confidential files in the hidden storage area, and whether or not to display on the computer device the confidential files stored in the hidden storage area. Thus, after a user stores a confidential file in the hidden storage area, no one else is allowed to find the storage location of the confidential file through the computer device. Furthermore, all the confidential files stored in the hidden storage area are protected from irrevocable loss caused by formatting or destructively overwriting the open storage area.

A further objective of the present invention is to provide an information storage device capable of hiding confidential files, wherein the information storage device comprises a storage unit and a secret chamber management unit. The storage unit is connected with the secret chamber management unit through a first connection interface while the secret chamber management unit is connected with a computer device through a second connection interface. The secret chamber management unit is installed therein with a user interface. The computer device reads and executes the user interface and obtains a storage capacity of the storage unit through the user interface. In addition, the secret chamber management unit sets an access authority selectively over the entirety or a part of the storage unit and formats the storage unit according to a command and a password inputted via the user interface, so as to create at least one physical, open storage area and at least one physical, hidden storage area in the storage unit. Further, an allocation management area is defined in the secret chamber management unit or the storage unit for storing management information related to the open storage area and the hidden storage area. Thus, the present invention provides an information storage device that not only enhances privacy protection and information security, but also effectively facilitates access of confidential files.

### BRIEF DESCRIPTION OF THE SEVERAL VIEWS OF THE DRAWINGS

The invention as well as a preferred mode of use, further objectives and advantages thereof will be best understood by referring to the following detailed description of illustrative embodiments in conjunction with the accompanying drawings, wherein:

FIG. 1 is a schematic drawing showing a framework of devices implementing a conventional encryption technique for virtual hard drives;

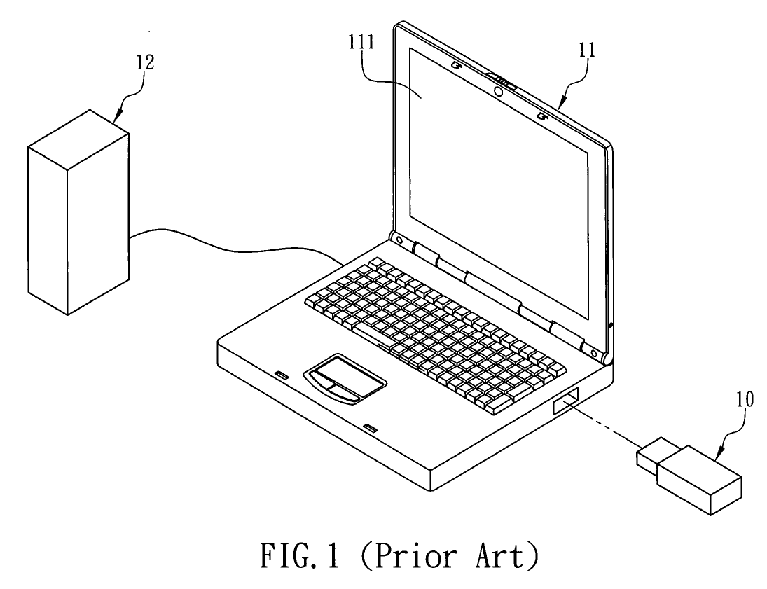

FIG. 2 shows a first image of a device directory as displayed on a computer screen of FIG. 1;

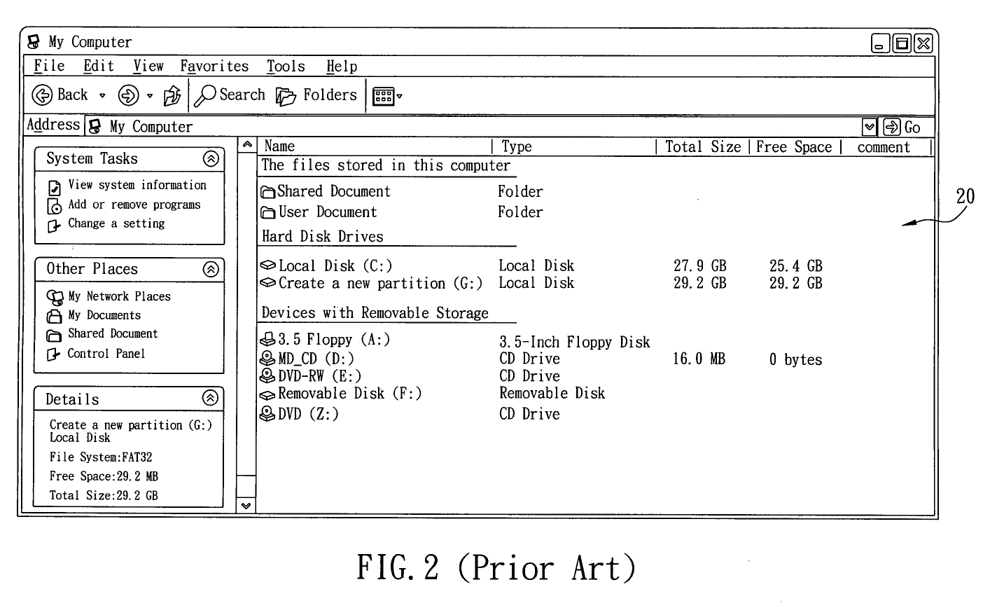

FIG. 3 shows a second image of the device directory as displayed on the computer screen of FIG. 1;

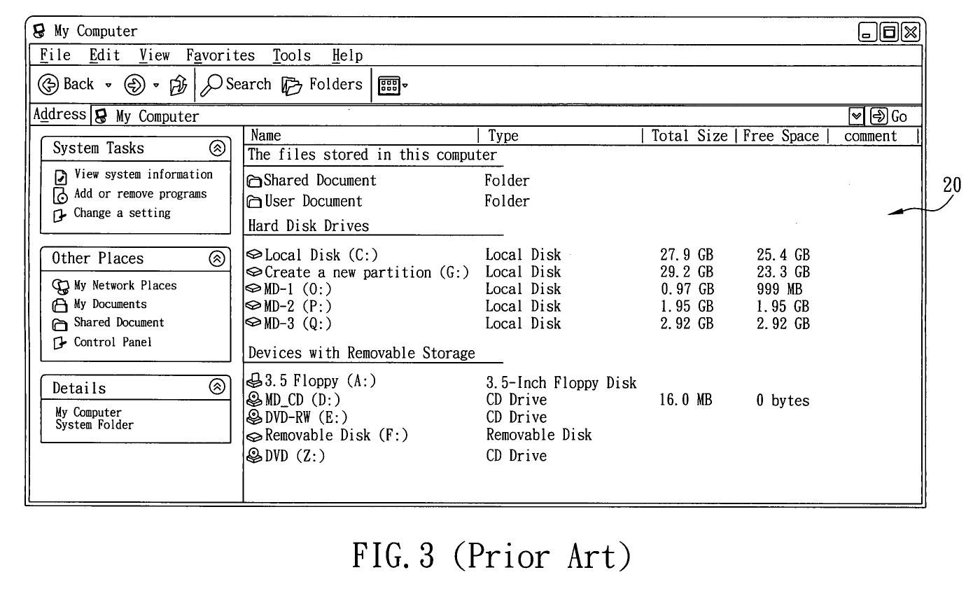

FIG. 4 shows a third image of the, device directory as displayed on the computer screen of FIG. 1;

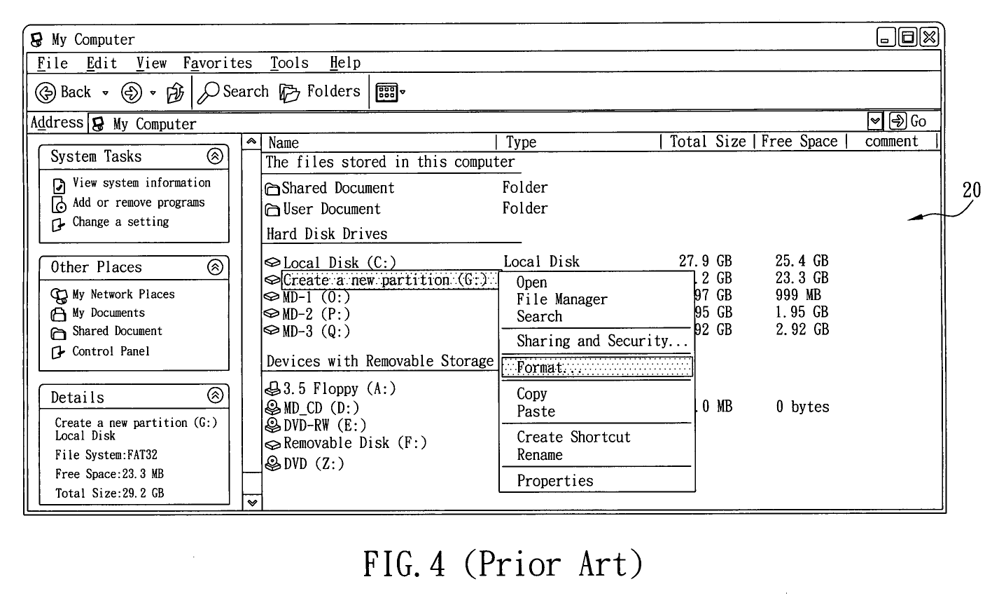

FIG. 5 shows a fourth image of the device directory as displayed on the computer screen of FIG. 1;

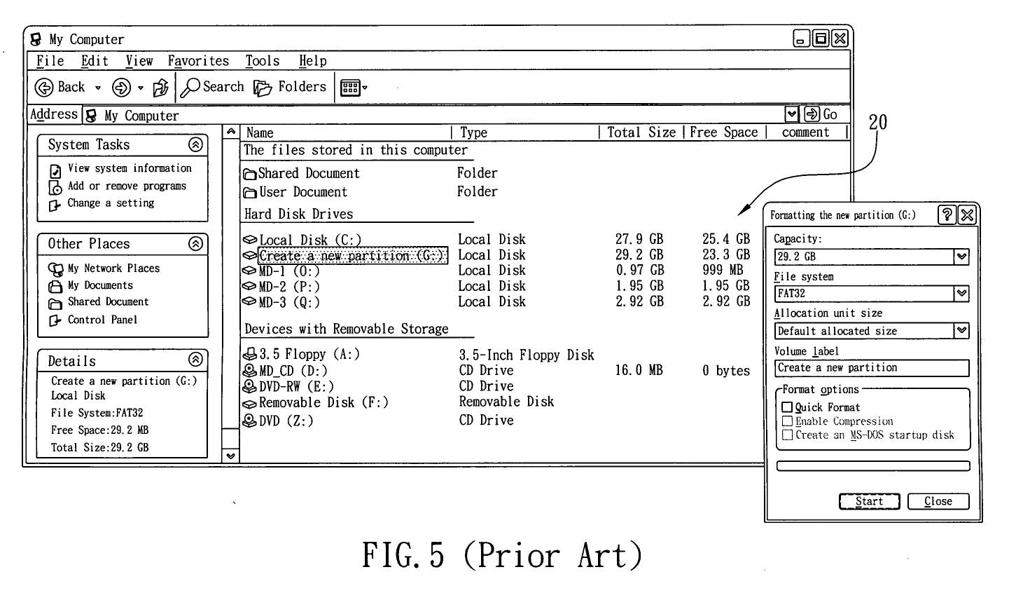

FIG. 6 shows a fifth image of the device directory as displayed on the computer screen of FIG. 1;

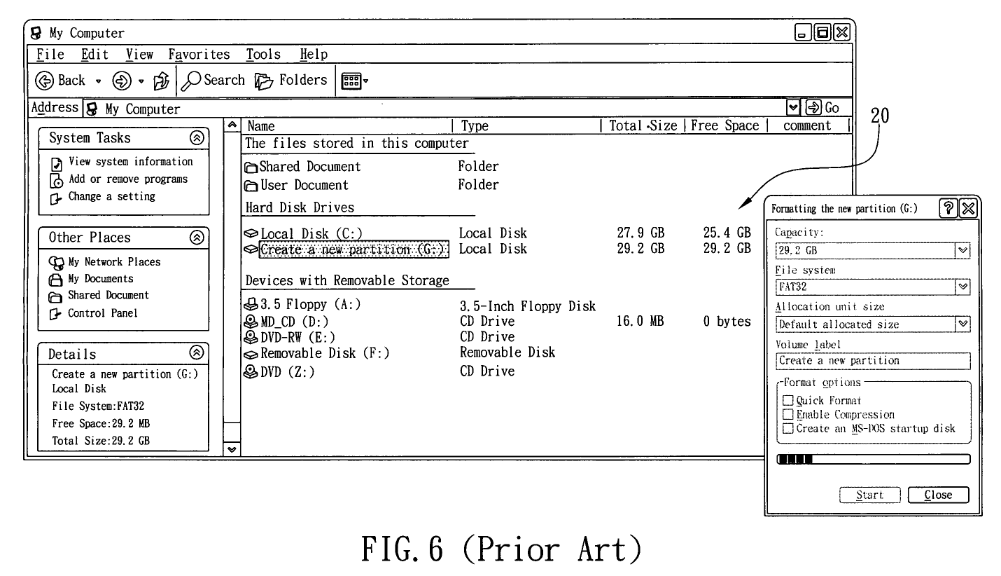

FIG. 7 is a schematic drawing showing a framework of a first embodiment of the present invention;

FIG. 8 is a flowchart for first-time connection between a computer device and an information storage device according to the first embodiment of the present invention;

FIG. 9 is a schematic drawing showing a framework of a second embodiment of the present invention;

FIG. 10 is a schematic drawing showing a framework of a third embodiment of the present invention; and

FIG. 11 is a flowchart for using the computer device to access a file in a storage unit according to the first embodiment of the present invention.

### DETAILED DESCRIPTION OF THE INVENTION

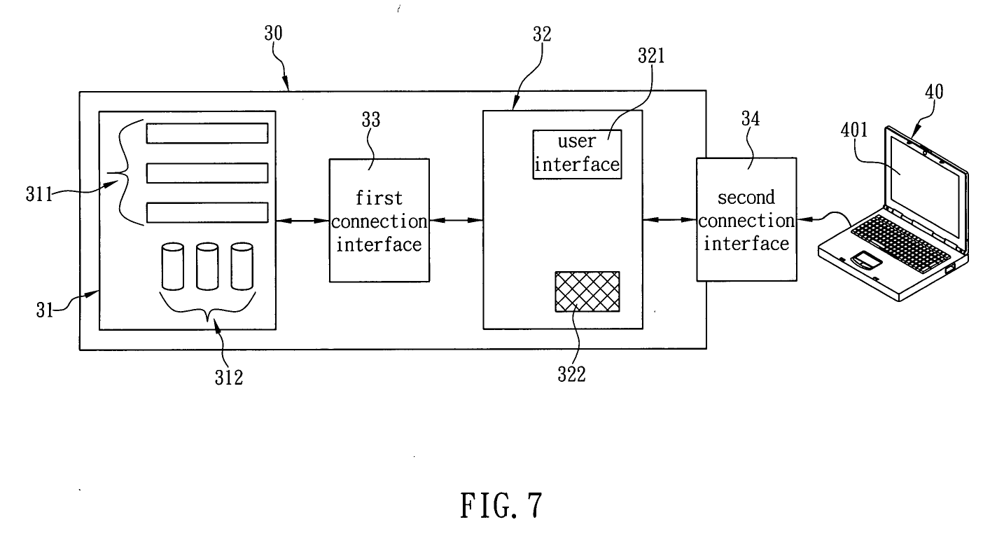

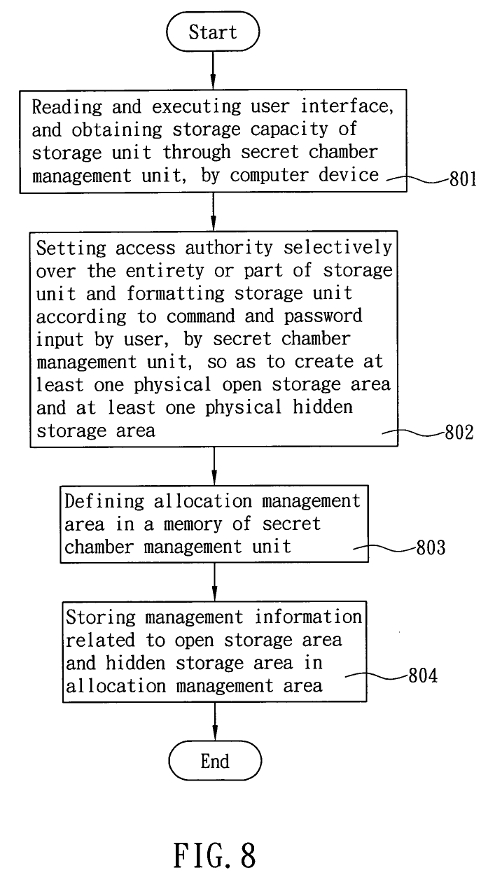

The present invention is directed to an information storage device and method capable of hiding confidential files. Referring to FIG. 7, the method is applicable to an information storage device (e.g., built-in hard drive, external hard drive, USB flash drive, IC card and other electronic devices for storing digital information) 30 comprising a storage unit 31 (e.g., hard drive, flash memory, etc.) and a secret chamber management unit 32, wherein the storage unit 31 is connected with a computer device (e.g., desk-top computer, notebook computer, personal digital assistant, mobile phone, etc.) 40 through the secret chamber management unit 32, and the secret chamber management unit 32 is installed therein with a user interface 321 (e.g., interface program). The method includes the following steps taken upon first-time connection of the computer device 40 and the information storage device 30, as shown by the flowchart in FIG. 8:
(801) reading and executing the user interface 321, obtaining a storage capacity of the storage unit 31 through the secret chamber management unit 32, and displaying the storage capacity of the storage unit 31 on a screen 401 of the computer device 40 for reference by a user, by the computer device 40, thereby allowing the user to input a command and a password to the computer device 40 via the user interface 321;.
(802) setting an access authority selectively over the entirety or a part of the storage unit 31 and formatting the storage unit 31 according to the command and the password inputted by the user, by the secret chamber management unit 32, so as to create at least one physical, open storage area 311 and at least one physical, hidden storage area 312 in the storage unit 31;
(803) defining a hidden allocation management area 322 in a memory of the secret chamber management unit 32; and
(804) storing management information related to the open storage area 311 and the hidden storage area 312 in the allocation management area 322.

Thus, according to the method, at least one physical, open storage area 311 and at least one physical, hidden storage area 312 are created in the storage unit 31 of the information storage device 30 for storing files of different attributes (e.g., non-confidential files and confidential files), respectively. While the present invention has been described above by reference to a first embodiment thereof, implementation of the present invention is not limited to the foregoing embodiment.

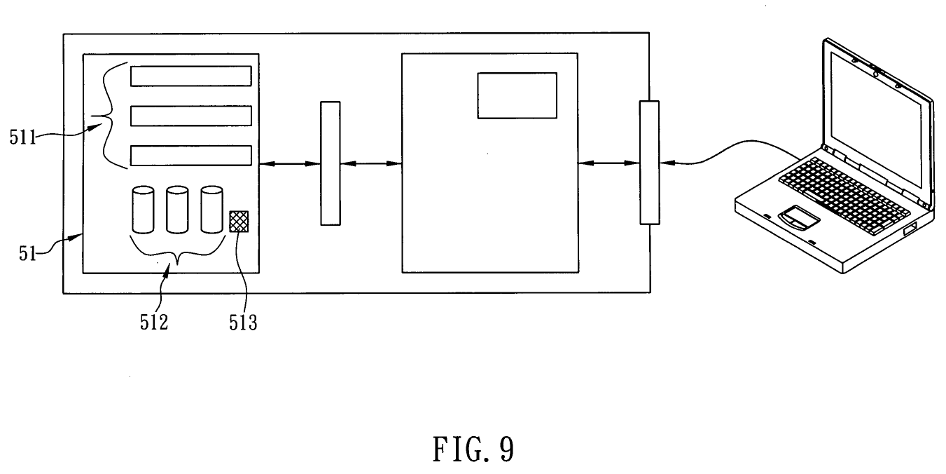

Referring now to FIG. 9 for a second embodiment of the present invention, the method includes creating at least one physical, open storage area 511 and at least one physical, hidden storage area 512 in a storage unit 51 and selectively defining a hidden allocation management area 513 in the storage unit 51. Afterward, management information related to the open storage area 511 and the hidden storage area 512 is stored in the allocation management area 513.

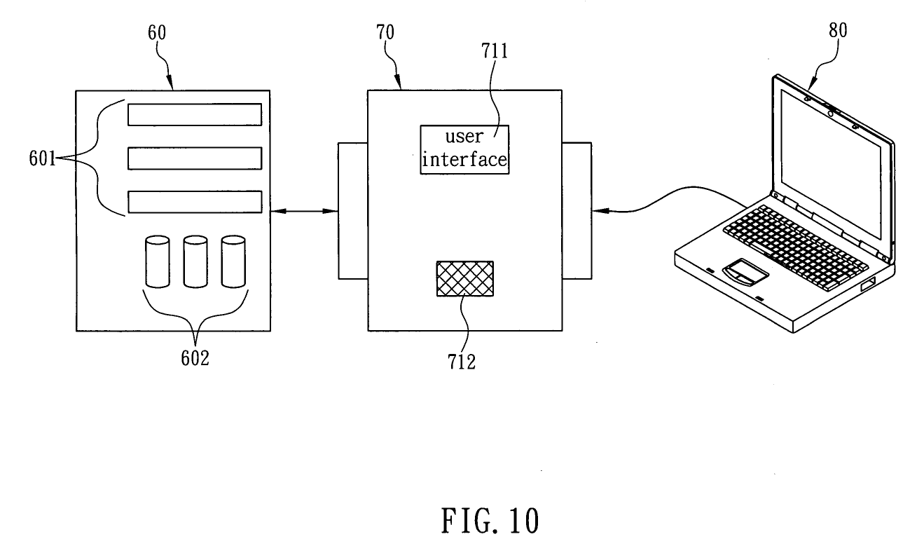

Referring now to FIG. 10, according to a third embodiment of the present invention, the method is also applicable to a storage device 60 (e.g., hard drive, flash memory, etc.) and a secret chamber management device 70 that are independent from each other, wherein the storage device 60 is connected with a computer device (e.g., desk-top computer, notebook computer, personal digital assistant, mobile phone, etc.) 80 through the secret chamber management device 70, and the secret chamber management device 70 is installed therein with a user interface 711. As previously described, the method includes the following steps for first-time connection between the computer device 80 and the storage device 60 through the secret chamber management device 70: creating at least one physical, open storage area 601 and at least one physical, hidden storage area 602 in the storage device 60; defining a hidden allocation management area 712 in a memory of the secret chamber management device 70 (or in the storage device 60); and storing management information related to the open storage area 601 and the hidden storage area 602 in the allocation management area 712. It should be noted that all equivalent changes that are based on the technical contents disclosed herein and readily conceivable by a person skilled in the art should be encompassed by the appended claims of the present invention.

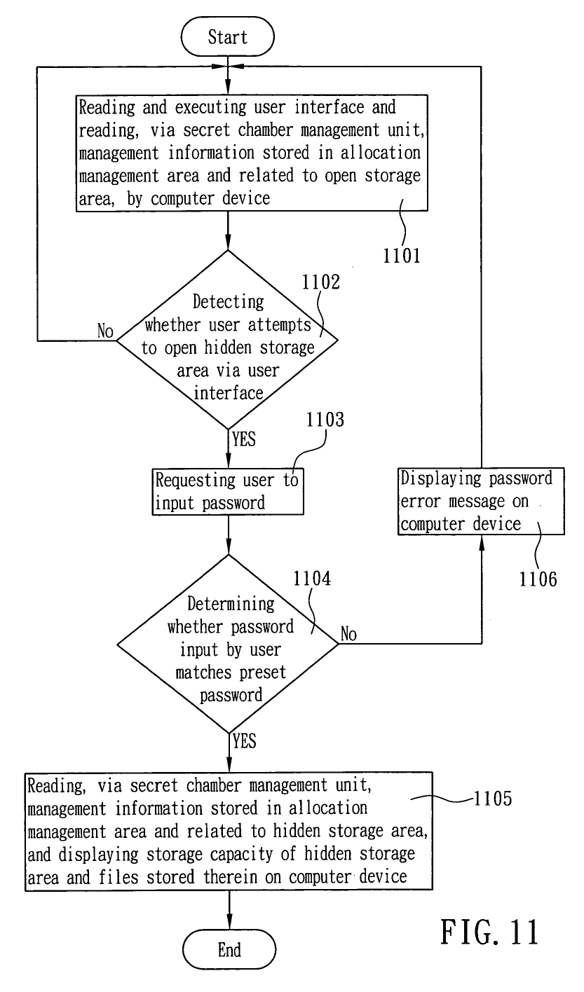

Referring to FIG. 7 again, to enable a user to access files in the storage unit 31 through the computer device 40 upon connection of the information storage device 30 and the computer device 40, the method further includes the following steps (as shown by the flowchart in FIG. 11):
(1101) reading and executing the user interface 321, reading via the secret chamber management unit 32 the management information stored in the allocation management area 322 and related to the open storage area 311, and displaying a storage capacity of the open storage area 311 along with files stored therein on the screen 401 of the computer device 40 for reference and selection by the user, by the computer device 40, thereby allowing the user to input a command and a password to the computer device 40 via the user interface 321;
(1102) detecting whether or not the user attempts, via the user interface 321, to open the hidden storage area 312 and display a storage capacity thereof along with files stored therein on the screen 401 of the computer device 40; if yes, the process goes on to step (1103); if not, the process returns to step (1101);
(1103) requesting the user to input the password;
(1104) determining whether or not the password inputted by the user matches a preset password; if yes, the process goes on to step (1105); if not, step (1106) is executed;
(1105) reading, through the secret chamber management unit 32, the management information stored in the allocation management area 322 and related to the hidden storage area 312; and displaying the storage capacity of the hidden storage area 312 and the files stored therein on the screen 401 of the computer device 40 for reference and use by the user; and
(1106) displaying a message about a password error on the screen 401 of the computer device 40; and refusing the user's attempt to open the hidden storage area 312 and display the storage capacity thereof and the files stored therein on the screen 401, before the process returns to step (1101).

Referring again to FIG. 7, when the information storage device 30 is connected with the computer device 40, a device directory displayed on the screen 401 of the computer device 40 shows only the storage capacity of the open storage area 311 and the files stored therein, but not the storage capacity of the hidden storage area 312 and the files stored therein. Therefore, despite the information displayed in the device directory, it is impossible for a third party to discern a hidden storage area in the information storage device 30, thereby preventing people from maliciously stealing confidential information by means of special decryption programs or techniques.

Referring once more to FIG. 7, to display the storage capacity of the hidden storage area 312 on the screen 401 of the computer device 40 or to access the files stored in the hidden storage area 312, it is necessary to follow the aforementioned steps, that is, executing the user interface 321, entering the password correctly, reading via the secret chamber management unit 32 the management information stored in the allocation management area 322 and related to the hidden storage area 312, and displaying the storage capacity of the hidden storage area 312 and the files stored therein on the screen 401 of the computer device 40 for reference and use by the user. It should be noted that, when the user or a third party (e.g., a maintenance engineer) attempts to format the open storage area 311, the computer device 40 formats only the open storage area 311 because the open storage area 311 and the hidden storage area 312 are two physical storage areas that totally independent from each other. Therefore, after the computer device 40 completes formatting the open storage area 311, the hidden storage area 312 is not affected at all; more specifically, the hidden storage area 312 will not be deleted from the storage unit 31, nor will the confidential files stored in the hidden storage area 312 be completely and irrevocably lost.

The present invention also provides an information storage device capable of hiding confidential files, as shown in FIG. 7, wherein an information storage device 30 includes a storage unit 31 and a secret chamber management unit 32. The storage unit 31 is connected with the secret chamber management unit 32 through a first connection interface 33, and the secret chamber management unit 32 is connected with a computer device 40 through a second connection interface 34. The secret chamber management unit 32 is installed therein with a user interface 321 such that when the information storage device 30 is connected with the computer device 40 for the first time, the computer 40 reads and executes the user interface 321, obtains a storage capacity of the storage unit 31 through the user interface 321, and display the storage capacity of the storage unit 31 on a screen 401 of the computer device 40 for reference by a user. The secret chamber management unit 32 sets an access authority selectively over the entirety or a part of the storage unit 31 and formats the storage unit 31 according to a command and a password inputted by the user, so as to create at least one physical, open storage area 311 and at least one physical, hidden storage area 312 in the storage unit 31. In addition, a hidden allocation management area 322 is defined in a memory of the secret chamber management unit 32 (or in the storage unit 31) for storing management information related to the open storage area 311 and the hidden storage area 312, thereby providing a file storage device which not only enhances privacy protection and information security, but also effectively facilitates access of confidential files.

The above description is provided only to illustrate an embodiment of the information storage device of the present invention. It is understood that implementation of the present invention is by no means limited to the foregoing embodiment. For example, referring to FIG. 9, a hidden allocation management area 513 is selectively defined in a storage unit 51, and management information related to an open storage area 511 and a hidden storage area 512 is stored in the allocation management area 513. Alternatively, referring to FIG. 10, the information storage device comprises a storage device 60 and a secret chamber management device 70 independent from each other. All equivalent changes to the disclosed information storage device that are based on the technical contents revealed herein and readily perceivable by one skilled in the art should fall within the scope of the present invention.

1. An information storage method capable of hiding confidential files, the method being applicable to an information storage device comprising a storage unit and a secret chamber management unit, the storage unit being connected with a computer device through the secret chamber management unit, the secret chamber management unit being installed therein with a user interface, the method, upon connection of the information storage device and the computer device, comprising steps of:
reading and executing the user interface, and obtaining a storage capacity of the storage unit through the secret chamber management unit, by the computer device;
setting an access authority selectively over an entirety or a part of the storage unit and formatting the storage unit according to a command and a password inputted by a user, by the secret chamber management unit, so as to create at least one physical open storage area and at least one physical hidden storage area in the storage unit;
defining an allocation management area in a memory of the secret chamber management unit; and
storing management information related to the open storage area and the hidden storage area in the allocation management area.

2. The method of claim 1, wherein the method, upon connection of the information storage device and the computer device and an attempt of the computer device to access files in the storage unit, further comprises steps of:
reading and executing the user interface, reading via the secret chamber management unit the management information stored in the allocation management area and related to the open storage area, and displaying a storage capacity of the open storage area and files stored therein on a screen of the computer device, by the computer device;
detecting whether the user attempts, via the user interface, to open the hidden storage area and display a storage capacity of the hidden storage area and files stored therein on the screen of the computer device; and
determining whether the password inputted by the user matches a preset password.

3. The method of claim 2, wherein, upon detection that the user attempts, via the user interface, to open the hidden storage area and display the storage capacity of the hidden storage area and the files stored therein on the screen of the computer device, the method further comprises:
requesting the user to input the password.

4. The method of claim 3, wherein, upon determination that the password inputted by the user matches the preset password, the method further comprises:
reading via the secret chamber management unit the management information stored in the allocation management area and related to the hidden storage area, and displaying the storage capacity of the hidden storage area and the files stored therein on the screen of the computer device.

5. The method of claim 3, wherein, upon determination that the password inputted by the user does not match the preset password, the method further comprises:
displaying a password error message on the screen of the computer device, and refusing to open the hidden storage area and display on the screen the storage capacity of the hidden storage area and the files stored therein.

6. An information storage method capable of hiding confidential files, the method being applicable to an information storage device comprising a storage unit and a secret chamber management unit, the storage unit being connected with a computer device through the secret chamber management unit, the secret chamber management unit being installed therein with a user interface, the method, upon connection of the information storage device and the computer device, comprising steps of:
reading and executing the user interface, and obtaining a storage capacity of the storage unit through the secret chamber management unit, by the computer device;
setting an access authority selectively over an entirety or a part of the storage unit and formatting the storage unit according to a command and a password inputted by a user, by the secret chamber management unit, so as to create at least one physical open storage area and at least one physical hidden storage area in the storage unit;
defining an allocation management area in the storage unit; and
storing management information related to the open storage area and the hidden storage area in the allocation management area.

7. The method of claim 6, wherein the method, upon connection of the information storage device and the computer device and an attempt of the computer device to access files in the storage unit, further comprises steps of:
reading and executing the user interface, reading via the secret chamber management unit the management information stored in the allocation management area and related to the open storage area, and displaying a storage capacity of the open storage area and files stored therein on a screen of the computer device, by the computer device;
detecting whether the user attempts, via the user interface, to open the hidden storage area and display a storage capacity of the hidden storage area and files stored therein on the screen of the computer device; and
determining whether the password inputted by the user matches a preset password.

8. The method of claim 7, wherein, upon detection that the user attempts, via the user interface, to open the hidden storage area and display the storage capacity of the hidden storage area and the files stored therein on the screen of the computer device, the method further comprises:
requesting the user to input the password.

9. The method of claim 8, wherein, upon determination that the password inputted by the user matches the preset password, the method further comprises:
reading, via the secret chamber management unit, the management information stored in the allocation management area and related to the hidden storage area, and displaying the storage capacity of the hidden storage area and the files stored therein on the screen of the computer device.

10. The method of claim 8, wherein, upon determination that the password inputted by the user does not match the preset password, the method further comprises:
displaying a password error message on the screen of the computer device, and refusing to open the hidden storage area and display on the screen the storage capacity of the hidden storage area and the files stored therein.

11. An information storage device capable of hiding confidential files, comprising:
a storage unit comprising at least one physical open storage area and at least one physical hidden storage area for storing digital information; and
a secret chamber management unit installed therein with a user interface, connected with the storage unit and a computer device for starting the user interface, respectively, and provided with a memory defined with an allocation management area for storing management information related to the open storage area and the hidden storage area;
wherein the secret chamber management unit selects, according to a command and a password inputted via the user interface, whether or not to display on the computer device the hidden storage area and confidential files stored therein according to the management information stored in the allocation management area.

12. The device of claim 11, wherein the storage unit is a hard drive.

13. The device of claim 11, wherein the storage unit is a storage device comprising a flash memory.

14. An information storage device capable of hiding confidential files, comprising:
a storage unit comprising at least one physical open storage area and at least one physical hidden storage area for storing digital information and defined therein with an allocation management area for storing management information related to the open storage area and the hidden storage area; and
a secret chamber management unit installed therein with a user interface and connected with the storage unit and a computer device for starting the user interface, respectively;
wherein the secret chamber management unit selects, according to a command and a password inputted via the user interface, whether or not to display on the computer device the hidden storage area and confidential files stored therein according to the management information stored in the allocation management area.

15. The device of claim 14, wherein the storage unit is a hard drive.

16. The device of claim 14, wherein the storage unit is a storage device comprising a flash memory.
